(19) United States
(12) Patent Application Publication
(10) Pub. No.: US 2002/0180882 A1
(43) Pub. Date: Dec. 5, 2002

(54) Apparatus and method for packaging an electronic imager allowing use of maximum active imaging area

(76) Inventor: Itzhak Sapir, Irvine, CA (US)

Correspondence Address: W. Eric Boyd, Esq., Buliding 3, 3001 Red Hill Ave., Costa Mesa, CA, 92626, US

(21) Appl. No.: 09/883,049

(22) Filed: Jun. 15, 2001

Related U.S. Application Data
(60) Provisional application No. 60/211,716, filed on Jun. 15, 2000.

(51) Int. Cl. H04N 5/225

(52) U.S. Cl. 348/373; 348/64

(57) ABSTRACT

An integrated circuit package housing an electronic imager die for use in a conventional SLR camera is disclosed. The package includes a substrate with conductive circuitry and an electronic imager die with a surface area approximately the size of a camera focal image plane mounted thereon. A frame with an inwardly depending lip and integral channel is bonded to the substrate and is provided with a transparent window, the window and frame residing at the focal image plane. The window and frame protect the active die surface from contamination. The channel volume is used for wirebond interconnects from the inactive perimeter of the imager die to the substrate circuitry. Additionally, the substrate contains additional area for supporting electronics or optional circuitry, all of which reside at the film rails and along the film path. In this manner, an electronic film package for use in a conventional camera is provided that allows the use of an imager die area of up to the size of the camera's focal image plane.

### CROSS-REFERENCE TO RELATED APPLICATIONS

This application claims priority benefit under 35 U.S.C. 119(e) from U. S. Provisional Application No. 60/211,716, filed Jun. 15, 2000, entitled, “SYSTEM AND METHOD OF PACKAGING AN ELECTRONIC IMAGER”.

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

The instant invention relates generally to digital photography. More specifically, the instant invention relates to an electronic imager package adapted for use with electronic film systems used in conventional 35-mm single lens reflex (SLR) cameras.

### BACKGROUND OF THE INVENTION

Digital photography has gained rapid acceptance by the professional and consumer owing to its flexibility, image quality, low lifetime cost of producing images and the ability to preview images prior to committing the image to hard copy.

Typically, the user of a digital photography system is required to purchase an integrated digital camera unit, consisting of a lens, shutter system, camera body and electronics. The digital camera includes an imager and associated electronics for capture, storage and output of photographic images. These “all-in-one” digital photography systems are readily available but fail to address the need of photographers who have considerable investment in, or allegiance to, conventional, film-based camera equipment and accessories.

To address this need, digital imaging devices or “electronic film systems” for use with conventional 35 mm camera bodies and lenses have recently been developed. These electronic film systems allow the use of conventional SLR camera equipment while maintaining the desirable benefits of digital camera systems. One such system is disclosed in U.S. Pat. No. 5,452,000, “Apparatus For Electronic Photography Using A Conventional Film Camera”.

Owing to cost and space concerns, existing electronic film systems commonly incorporate an electronic imager die that is smaller than the imaging area of the camera being used. Unfortunately, the use of a relatively small imager die does not take full advantage of the entire area of the focal image plane provided by a conventional SLR camera, which is typically 24 mm by 36-mm.

This is primarily due to the fact the imager die, support electronics and related structure all must reside within the very small space between the camera back and the shutter curtain aperture. Compounding the focal plane utilization problem is the fact all electronic imager die contain at least one inactive area about the die perimeter, limiting the imager die surface available for imaging. This inactive area is necessary for electrical interconnects (e.g.-wirebonds) between the electronic imager die and the off-die supporting electronics.

Recent advances in the manufacture of electronic CMOS and CCD imagers have made it cost-effective to utilize an imager that effectively occupies the entire focal image plane of a 35 mm camera, i.e.-a 24 mm by 36 mm active image area, but these larger imagers create correspondingly larger challenges.

Specifically, the entire electronic imager surface must be exactly coplanar with the focal image plane at the correct distance therefrom and still fit within the shutter curtain aperture of a camera. A larger die makes this difficult to accomplish. Any substantial variation of the distance or planar angle of the imager with respect to the focal image plane will result in poor quality images.

Yet another difficulty encountered in using large area electronic imager die is that all components of an electronic film system must fit within the limited space of the interior of a camera. The mere fact the die is larger means the space limitations of a camera interior become significantly more problematic. Electronic film systems require, at a minimum, an electronic imager die, a supporting substrate, wire bonding, an imager die housing and window, and space for related electronics. All of these components must reside and remain aligned in the very small space between the camera back and the focal image plane. All of these limitations are greatly multiplied when a large area imager die is desired for use in an electronic film system simply because the space available for supporting electronic circuitry is reduced by the space occupied by the imager.

Thus, the need has arisen for an electronic imager package that utilizes a full focal plane imager, yet is sufficiently compact to reside in the focal image plane of an existing camera body while maintaining precise planar alignment therewith.

### BRIEF SUMMARY OF THE INVENTION

It is an object of the instant invention to overcome the above limitations of devices presently in use by providing a full focal image plane electronic imager package that maintains accurate alignment of the imager die surface with the focal image plane of a camera, yet fits within the limited space provided by a shutter aperture area and film rail volume.

It is a further object of the instant invention to provide an electronic imager package which is both inexpensive to produce, and which provides an area for supporting electronics or additional integrated circuit die.

These, together with other objects of the invention, along with the various features a novelty which characterize the invention, are pointed out with particularity in the claims annexed to and forming a part of this disclosure. For better understanding of the invention, its operating advantages and the specific objects attained by its uses, reference should be made to the accompanying drawings and descriptive matter in which there is illustrated a preferred embodiment of the invention.

The present invention achieves these objects by taking advantage of the space/volume existing in conventional SLR cameras between the film rails and along the film path, which is outside of the imaging area. Supporting electronic circuitry is provided along the film rail, and space taken up by the interconnect area and wirebonding height is reoriented to the perimeter of the focal image plane within the film rail volume. A novel window frame structure is provided, freeing up valuable imager space at the focal image plane itself.

In accordance with the present invention, a compact, fall focal plane electronic imager package is provided. The package includes a substrate with an electronic imager die bonded to it. The imager die has an active surface substantially equivalent to the focal image plane area of the camera in which it will be used. A frame that receives an optically transparent window is set about the imager die and bonded to the substrate in a manner so as to receive the inactive surface of the imager die. An interconnect channel is provided within the window frame to accommodate wirebonding of the die to supporting electronic circuitry without utilizing the focal image plane. The window frame is adapted so as to be received within the shutter curtain aperture of the camera.

The window frame may optionally be manufactured from an optically transparent material to allow angular light to be received by the die through the frame itself.

One alternative embodiment includes a transparent window with an angular chamfer about its image surface to facilitate angular light upon the die surface.

Yet another embodiment provides a reference plane on the window housing for alignment of the imager die surface with the focal image plane.

Yet another embodiment includes an interconnect channel and substrate which accommodates at least one integrated circuit die such that the package becomes a multi-chip module (MCM).

### BRIEF DESCRIPTION OF THE SEVERAL VIEWS OF THE INVENTION

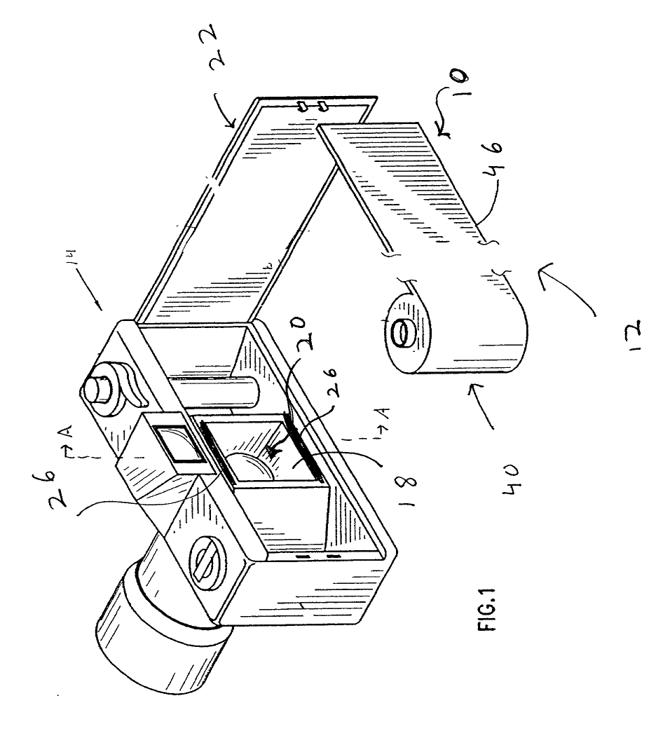

FIG. 1 is a perspective view illustrating a conventional camera and electronic film system showing the electronic imager package which is the subject of the present invention.

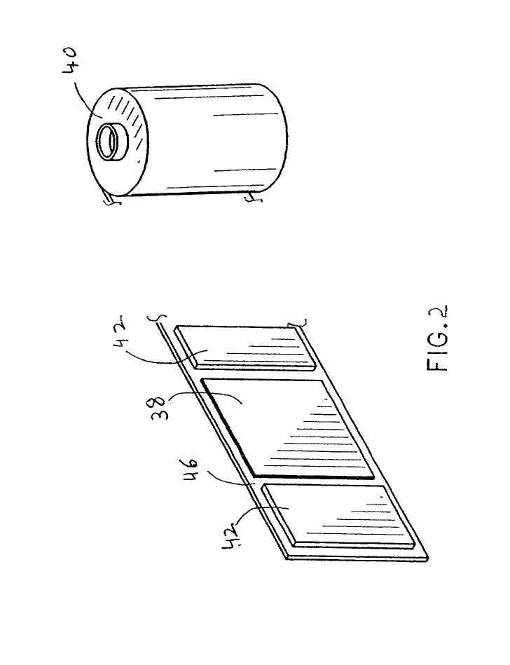

FIG. 2 is a perspective view of an electronic film system showing the general relationship of the electronic imager die and supporting electronics which are the subject of the present invention.

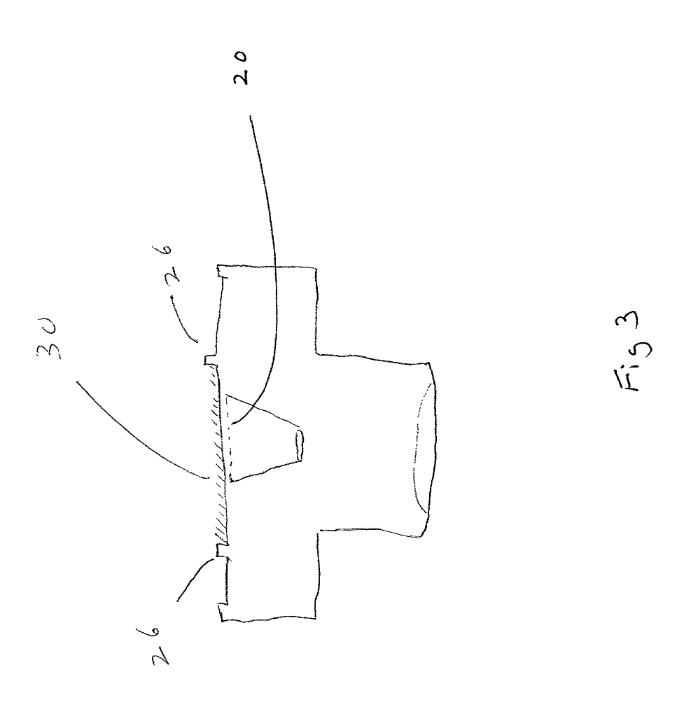

FIG. 3 is a cross section of a conventional camera taken along A-A showing film rail projections along the film plane.

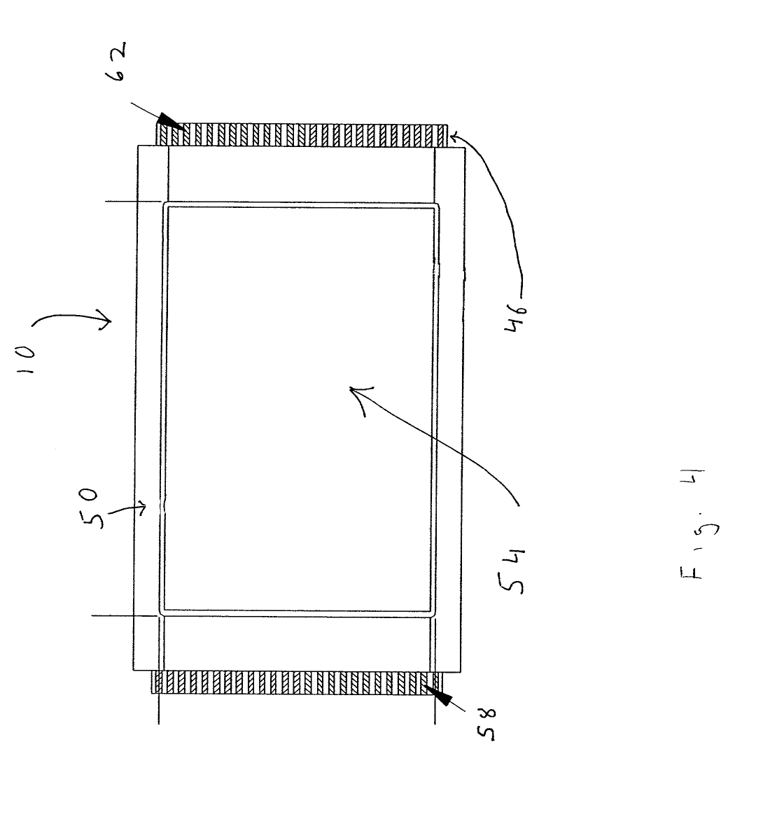

FIG. 4 is a top view of the electronic imager package which is the subject of the present invention.

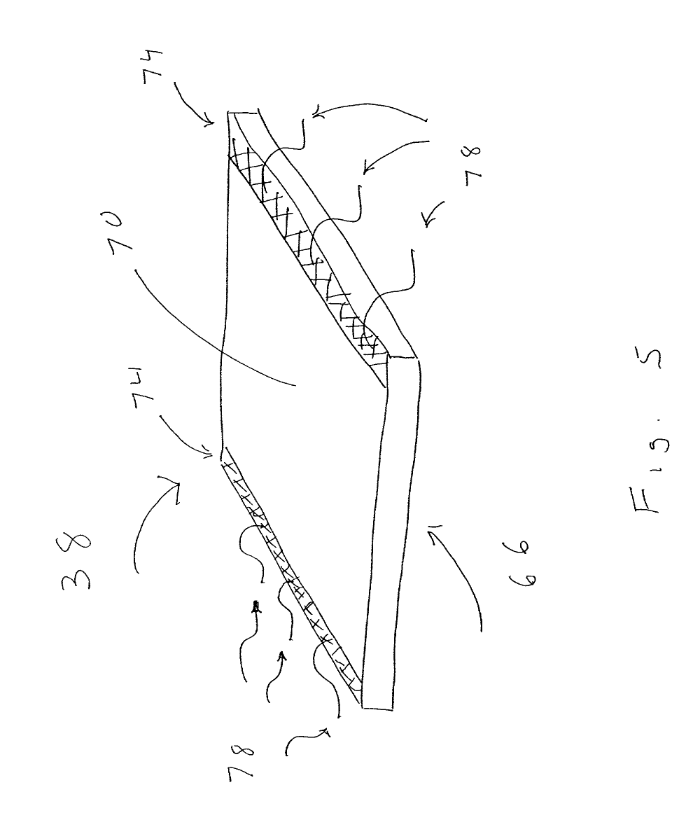

FIG. 5 is a perspective view of an electronic imager die showing the interconnect area.

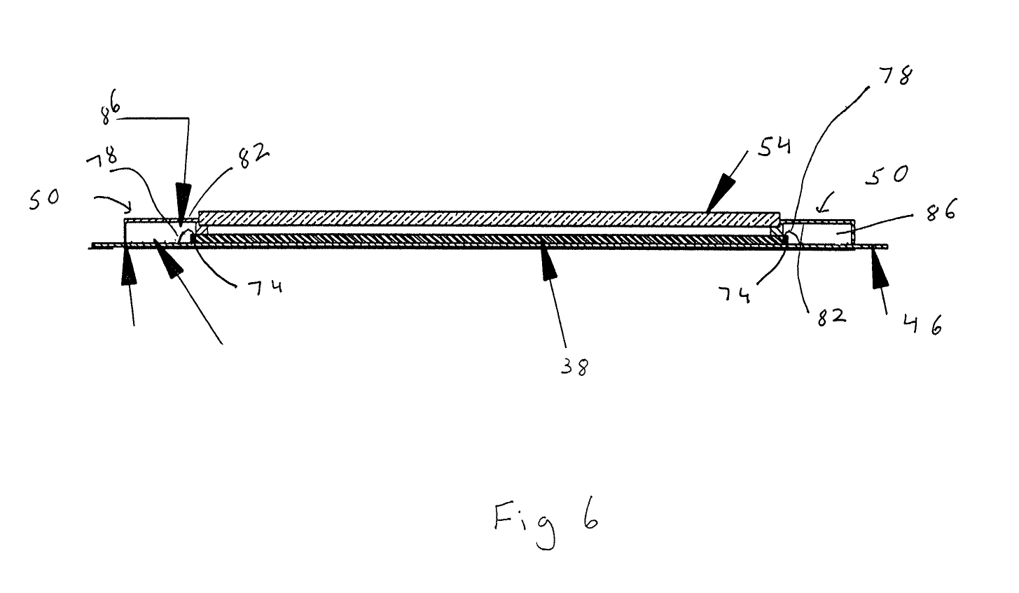

FIG. 6 is a cross-section of a preferred embodiment of the present invention.

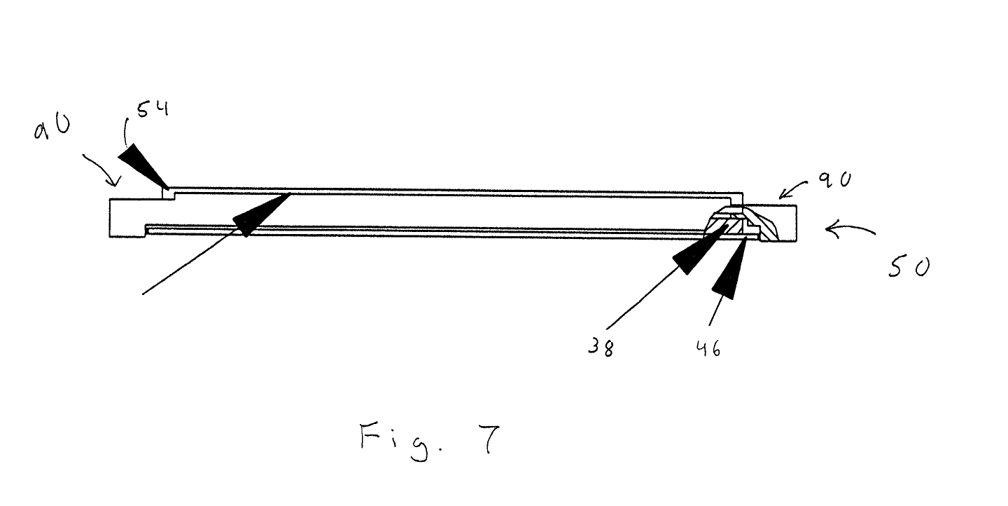

FIG. 7 is a different view of the preferred embodiment of the present invention showing the invention with a reference plane surface.

### DETAILED DESCRIPTION OF THE INVENTION

Referring now to the drawings in which like numerals refer to like elements among the several views, a general illustration of the electronic imager package 10 which is the subject of the present invention is shown in FIG. 1. Also shown is associated electronic film system 12 for use in conventional camera 14. Electronic film system 12 includes electronic imager package 10 and a power supply 40. Camera 14 includes a focal image plane 18, a shutter curtain aperture 20 and a camera back 22. Film rails 26 are typically formed on the interior portion of camera 14 to accommodate and align conventional film.

FIG. 2 discloses an opposing view of electronic film system 12 from that of FIG. 1, and shows the relative relationship of electronic imager die 38, power supply 40 and electronic circuitry 42 on substrate 46 of electronic imager package 10.

FIG. 3 shows a cross section of camera 14 taken along A-A of FIG. 1 and illustrates film rails 26 and the film rail volume 30 created thereby.

FIGS. 4 and 5 illustrate a preferred embodiment of the electronic imager package and imager die of the subject invention.

As can be seen, electronic imager package 10 includes substrate 46, window frame 50, window 54, a first projection 58 and a second projection 62. In the invention's preferred embodiment, substrate 46 is a stable, electrically insulating material such as ceramic or FR4, and includes at least one layer of electrically conductive traces (not shown) for routing electrical signals. Substrate 46 optionally may be a multi-layer construction, much like conventional printed circuit boards. Substrate 46 also includes the electronic imager die 38 of FIG. 4, such as a CMOS die or CCD die, with an inactive surface 66, an active surface 70 and an interconnect area 74 for wirebond interconnects 78. Interconnect area 74 is a passive portion of all electronic imaging die used to route electrical signals to and from the substrate and die. Electronic imager die 38 is preferably bonded to substrate 46 using any suitable adhesive such as a nonconductive epoxy.

Bump bonding or the use of pin grid array connections may be utilized for appropriate imager die configurations. The area of active surface 70 is preferably substantially that of the area of the focal image plane of the camera it will be used in. In a conventional 35-mm camera, the active surface of electronic imager die 38 would preferably be 24 mm×36 mm.

First projection 58 and second projection 62 shown of FIG. 4 are terminal portions of substrate 46 that extend under and laterally beyond window frame 50 and are provided to allow electrical connections to a power supply or additional electronics necessary in electronic film systems.

Turning now to FIGS. 6 and 7, the structure and cooperation of the key elements of the present invention are shown. FIG. 6 discloses substrate 46 with an electronic imager die 38 bonded thereto. Window 54 is received by window frame 50. Window frame 50 is formed so as to be received by and within the shutter curtain aperture of a camera and may be made from a variety of materials, preferably a polymer which may optionally be optically transparent. Window frame 50 further is provided with an inwardly depending lip 82 which forms interconnect channel 86.

Window 54 is received by window frame 50 and bonded thereto. Window frame 50 is bonded to substrate 46 whereby electronic imager die 38 is received by inwardly depending lip 82 and so that interconnect area 74 of electronic imager die 38 extends into interconnect channel 86. Window frame 50 is preferably configured to as to allow maximum exposure of active surface 70 to window 54.

Wirebond interconnects 78 are attached along interconnect area 74 for connection to electrically conductive traces (not shown) on substrate 46. In this manner, all interconnections and non-active areas of electronic imager die 38 are removed from the focal image plane and shifted to a location outside of the focal image plane of a camera. The configuration of inwardly depending lip 82 and interconnect channel 86 provide a unique structure that allows maximum active area of an electronic imager die to reside directly and fully within the focal image plane of a camera. This is accomplished by reorienting non-active die area, interconnects and supporting circuitry off of the focal image plane to allow the active surface of the imager to reside accurately within the between a camera's film rails and by and within a shutter curtain aperture. Interconnect area 74 and wirebond interconnects 78 reside within interconnect channel 74 of window frame 50. This configuration desirably takes advantage of the film rail volume that exists in all conventional SLR cameras.

FIG. 7 illustrates a different view of the preferred embodiment of the present invention whereby the window frame includes an external reference plane surface 90 that allows precise alignment of the electronic imager die surface with focal image plane of the camera. Reference plane surface 90 is included on window frame 50 and is received by the shutter curtain aperture of a camera to allow precise alignment of electronic imager die 38 with the camera focal image plane. Such a reference plane configuration is disclosed in U.S. Pat. No. 6,147,389, “Image Sensor Package With Image Plane Reference”.

In another preferred embodiment, interconnect channel 74 may be used to allow the placement and interconnection of additional integrated circuit die (not shown) on substrate 46, whereby the subject invention becomes a multi-chip module (MCM) with greatly enhance processing/imaging capacity.

It can therefore be seen that the present disclosure allows for an integrated circuit package that is sufficiently compact to fit within a conventional SLR camera and which maintains accurate alignment of the active surface of the electronic imager. It can further be seen that the present invention provides an integrated circuit package which allows an active surface area of an electronic imager die which is substantially equal to the entire focal image plane of a camera.

Moreover, having thus described the invention, it should also be apparent that numerous structural modifications and adaptations maybe resorted to without departing from the scope and fair meeting of the instant invention as set forth herein above and as described herein below by the claims.

What is claimed:

1. An integrated circuit package for housing an integrated imaging die, said package providing a reference plane in relation to an image plane of said die, said package comprising:
a transparent window, a window standoff with an internal plane acting as said reference image plane and an external plane acting as reference positioning plane for said package when interfacing with an external optical device, a substrate on which the said imager die is mounted, said package is designed to accommodate an imager die that is bigger than said window, whereby the active imaging area of the imager die is as big as the external device allows (determined by the shutter rectangular opening in the case of a 35 mm camera) and providing an interconnection area between said die and the package that is outside the imaging area.

2. A package of claim 1 further having the substrate designed as a single or multi layer electrically conductive circuitry and having said imager die electrically connected to it.

3. A package of claim 2 further comprising an area were the traces extend beyond the window standoff dimensions to form a group of pads for connecting the imager to external circuitry.

4. A package of claim 2 further comprising additional dies that are mounted on the said substrate in the said interconnection area to form a MCM (Multi Chip Module) device.

5. A package of claim 1 that when designed for 35 mm cameras provides a thicker interconnection area than the rest of the package taking advantage of the fact that there is a recess in 35 mm cameras between the film rails. Said thicker area allows for electrical interconnection methods that require some height above the image plane of the die (such as wire bonding). It also allows for thicker dies as described in claim 4.

6. An integrated circuit package housing an electronic imager die for use in a conventional SLR camera comprising:
a substrate adapted so as to be received upon the film rail of said camera and containing at least one layer of electrically conductive circuitry, said substrate including an electronic imager with an active surface and an interconnect area, said active surface substantially equal to the focal image plane of said camera, means for electrically connecting said electronic imager to said conductive circuitry outside of said focal image plane.

7. An integrated circuit package for housing an electronic imager die for use in a conventional camera comprising:
a substrate containing at least one layer of electrically conductive circuitry, said substrate having a first projection and a second projection, said substrate adapted so as to be received upon a film rail;
an electronic imager die having an active surface substantially equal to the focal image plane of said camera and including an interconnect area and an inactive side, said inactive side bonded to said substrate, said interconnect area electrically connected at least one location to said conductive circuitry;
a frame adapted so as to be received within the shutter curtain aperture of said camera and within the film rail volume of said camera and bonded to said substrate, said frame having an inwardly depending lip and including an interconnect channel; wherein said interconnect area is received by said lip and protrudes into said interconnect channel;
a transparent window mounted on said frame and overlying said electronic imager die.

7. The integrated circuit package of claim 7 wherein said frame includes at least one reference plane surface.

8. The integrated circuit package of claim 7 wherein said frame is made from an optically transparent material.

9. The integrated circuit package of claim 7 wherein said window includes a chamfer about its perimeter.

10. A window frame for receiving an integrated circuit die comprised of:
a frame with a top surface and an bottom surface, said top surface having an integral inwardly depending lip about its interior perimeter, said bottom surface including an interconnect channel about its interior perimeter.

11. The frame of claim 10 wherein said frame is adapted so as to be received by the shutter curtain aperture of a camera.
